(19) United States
(12) Patent Application Publication
(10) Pub. No.: US 2023/0391367 A1
(43) Pub. Date: Dec. 7, 2023

(54) INFERRING AUTONOMOUS DRIVING RULES FROM DATA

(71) Applicant: Motional AD LLC, Boston, MA (US)

(72) Inventors: Calin Belta, Sherbon, MA (US); Cristhian Guillermo Lizarazo Jimenez, Boston, MA (US); Anne Collin, Cambridge, MA (US); Shakiba Yaghoubi, Cambridge, MA (US); Noushin Mehdipour, Allston, MA (US); Amitai Bin-Nun, Boston, MA (US)

(21) Appl. No.: 17/818,861

(22) Filed: Aug. 10, 2022

Related U.S. Application Data
(60) Provisional application No. 63/365,694, filed on Jun. 1, 2022.

(51) Int. Cl. B60W 60/00; G06N 5/00

(52) U.S. Cl. CPC B60W 60/0015; G06N 5/003

(57) ABSTRACT

Provided are methods, systems, and computer program products for inferring and using vehicle trajectory standards. An example method may include: obtaining a training dataset associated with an autonomous vehicle action, the training dataset comprising trajectory data for a plurality of examples of the autonomous vehicle action and labels for each of the plurality of examples; generating a decision tree based on the trajectory data and the labels of the training dataset; determining a vehicle trajectory standard based on the decision tree; and communicating the vehicle trajectory standard to at least one autonomous vehicle, wherein the at least one autonomous vehicle uses the vehicle trajectory standard to select a vehicle trajectory for the at least one autonomous vehicle.

### INCORPORATION BY REFERENCE TO ANY PRIORITY APPLICATIONS

This application claims the priority benefit of U.S. Provisional Patent Application No. 63/365,694, entitled INFERRING AUTONOMOUS DRIVING RULES FROM DATA, filed on Jun. 1, 2022, which is incorporated herein by reference in its entirety.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5A is a block diagram illustrating an example environment in which an inference system infers vehicle trajectory standards;

FIG. 5B is a diagram illustrating an example decision tree to infer vehicle trajectory standards;

FIG. 6 is a flow diagram illustrating an example of a routine implemented by one or more processors to infer vehicle trajectory standards; and

FIG. 7 is a flow diagram illustrating an example of a routine implemented by one or more processors to select a vehicle trajectory based on a vehicle trajectory standard.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Autonomous vehicles may plan vehicle trajectories and execute control instructions to operate the autonomous vehicles to follow the vehicle trajectories. For instance, autonomous vehicles may determine whether vehicle trajectories adhere to vehicle trajectory standards (e.g., sets of conditions for safe, comfortable, and/or legal requirements (such as speed limits), and the like, for operation of an autonomous vehicle). Vehicle trajectory standards underlying good driving behaviors may often be underspecified or difficult to formulate (e.g., based on complex interactions of machine learning networks). As an example, a combination of timing of turning, forward accelerations, initial approach, curvature, and the like that lead to a comfortable ride (e.g., in the experience of a user in the autonomous vehicle) may be hard to derive analytically.

In some cases, certain vehicle trajectory standards, such as pedestrian clearance, maximum speed, and the like, may be easily (e.g., manually) translated to formulas of Boolean and temporal logics, which are interpretable by users and explainable. In other cases, certain other vehicle trajectory standards, such as particular good (safe) or bad (unsafe) behaviors, may be learnt from data. In certain cases, machine learning techniques may provide classifiers for such vehicle trajectory standards that may not be interpretable by users. However, it may be desirable to have all vehicle trajectory standards formalized in a logic that is expressive enough to capture all vehicle trajectory standards but simple enough to be interpretable and explainable.

Thus, in some aspects and/or embodiments, systems, methods, and computer program products described herein include and/or implement an inference system to infer vehicle trajectory standards. As a non-limiting example, the inference system may infer vehicle trajectory standards based on training data. In some cases, the vehicle trajectory standards may be inferred for particular autonomous vehicle actions. In some cases, the training data may be based on positive and negative examples collected from traffic data and/or simulations. In some cases, the inference system may determine the vehicle trajectory standards from decision trees generated based on the training data. In some cases, the vehicle trajectory standards may be interpretable and explainable.

In some cases, to generate the decision trees, the inference system may use conditions (e.g., formulas), at every node, to split traces of the training data. For instance, the inference system may split the traces by selecting a first group based on a first condition and associating the first group with a first child node. The inference system may associate a second group of traces that did not satisfy the first condition with a second child node. The inference system may evaluate the conditions on a vehicle trajectory, speed, distance to an object, acceleration, and the like.

In some cases, the inference system may select the first condition by ranking a plurality of conditions using an impurity reduction measure. The impurity reduction measure may quantify a quality of a split for a condition. The inference system may then select a highest ranked condition as the first condition. For instance, the impurity reduction measure may be an information gain measure, a Gini gain measure, a misclassification gain measure, and the like. Generally, a good split may result in a group of traces that are “pure” (that is, contain objects of a same class).

In some cases, the inference system may reclusively split successive child nodes until a continuation condition is not satisfied. The continuation condition may indicate a group of traces is not “pure” (that is, contains a mix of objects of different classes). For instance, the objects may be traces, and the classes may be labels of the traces. In some cases, the inference system may determine the continuation condition is satisfied when traces of a group include traces labeled a first label (e.g., a positive example of an autonomous vehicle action) and traces labeled a second label (e.g., a negative example of the autonomous vehicle action). In some cases, the inference system may determine the continuation condition is not satisfied when traces of a group include only traces (or a threshold percentage of traces) labeled the first label. In response to the continuation condition being not satisfied, the inference system may determine the decision tree is complete. In some cases, the inference system may use boosted decision tree generation to generate the decision trees.

In some cases, the inference system may determine the vehicle trajectory standard by traversing a complete decision tree. For instance, the inference system may traverse a positive path of the decision tree and retrieve each condition for each node along the positive path. In some cases, the vehicle trajectory standard may be constructed using signal temporal logic (STL) with the retrieved conditions from the nodes along the path. Thus, the vehicle trajectory standard may define a logic that is expressive enough for autonomous vehicle applications yet simple enough to make learning computationally feasible.

In some cases, the inference system may provide vehicle trajectory standards in a same format as traffic law constraints. Thus, the present methods and systems may provide a unified framework to represent traffic laws and vehicle trajectory standards that indicate good vehicle behavior. In some cases, the vehicle trajectory standards are interpretable. Thus, a human may understand how a vehicle trajectory standard is being applied. In some cases, the vehicle trajectory standards are generated using training data that includes examples of good and bad behavior. Thus, the vehicle trajectory standards may be learned automatically from data. In some cases, satisfaction of the vehicle trajectory standards are quantifiable. Thus, in run-time, a planning system can select vehicle trajectories in accordance with no vehicle trajectory standards violations or prioritized vehicle trajectory standards violations (e.g., cannot violate a first vehicle trajectory standard (for safety) but could violate a second vehicle trajectory standard (for comfort)).

By virtue of the implementation of systems, methods, and computer program products described herein, an autonomous vehicle or AV system can select vehicle trajectories that satisfy vehicle trajectory standards inferred from examples of labeled acceptable or not. Therefore, systems of the present disclosure may execute autonomous vehicle actions in accordance with vehicle trajectory standards that correspond to vehicle actions labeled as acceptable.

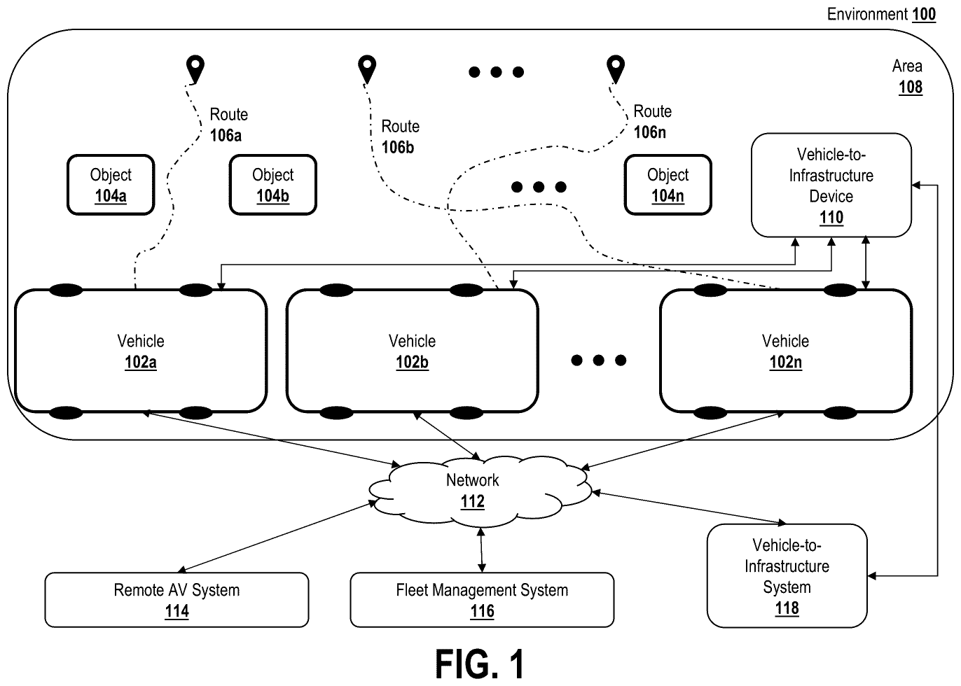

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

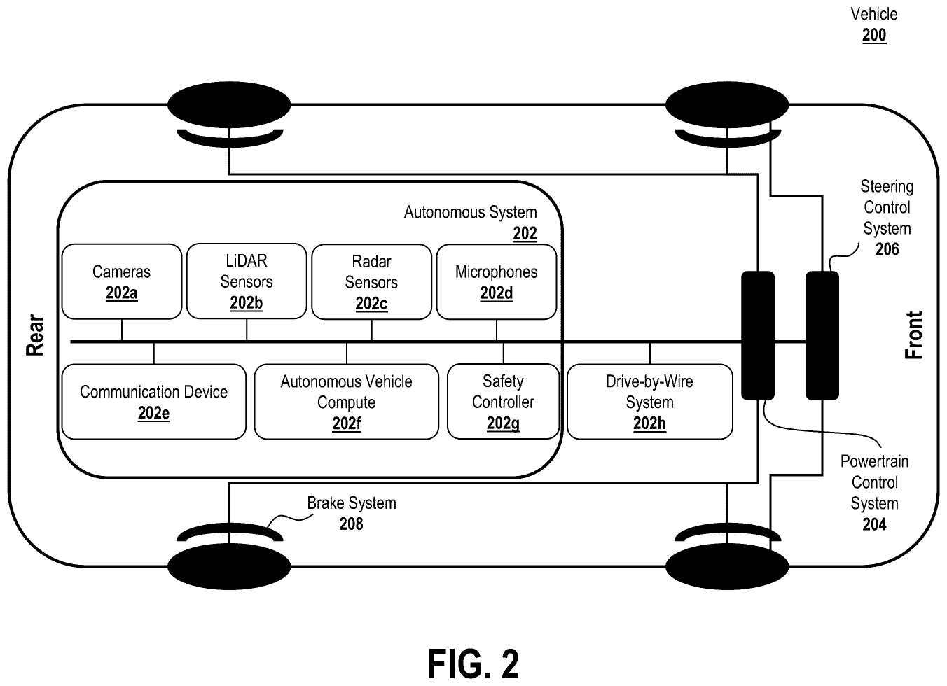

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

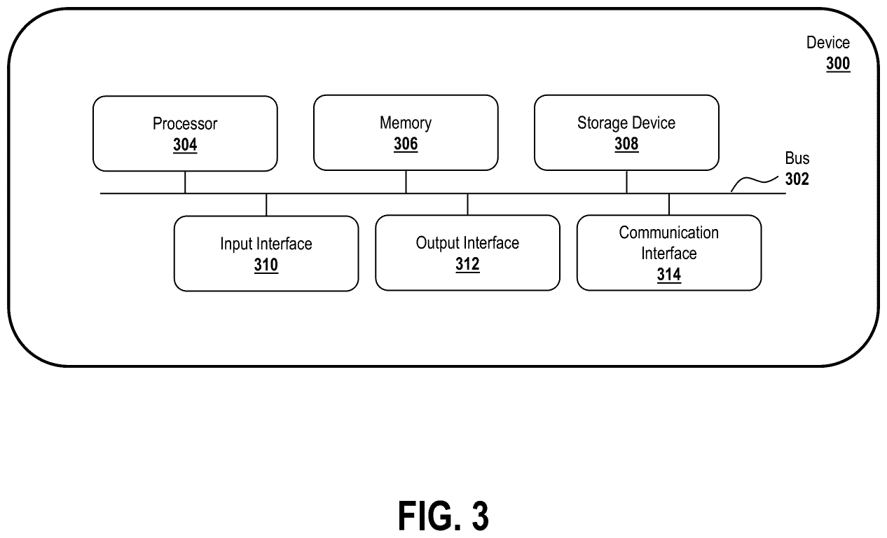

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data (TLD data) associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid-state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally, or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

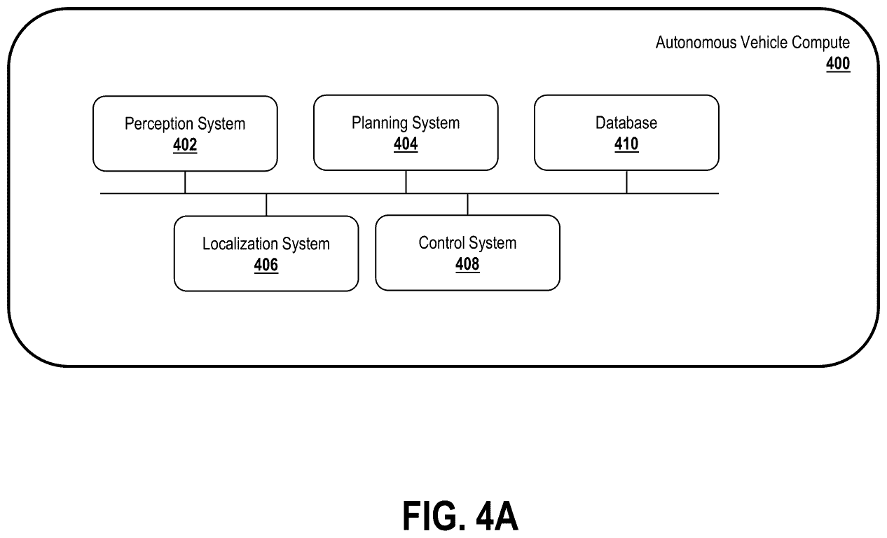

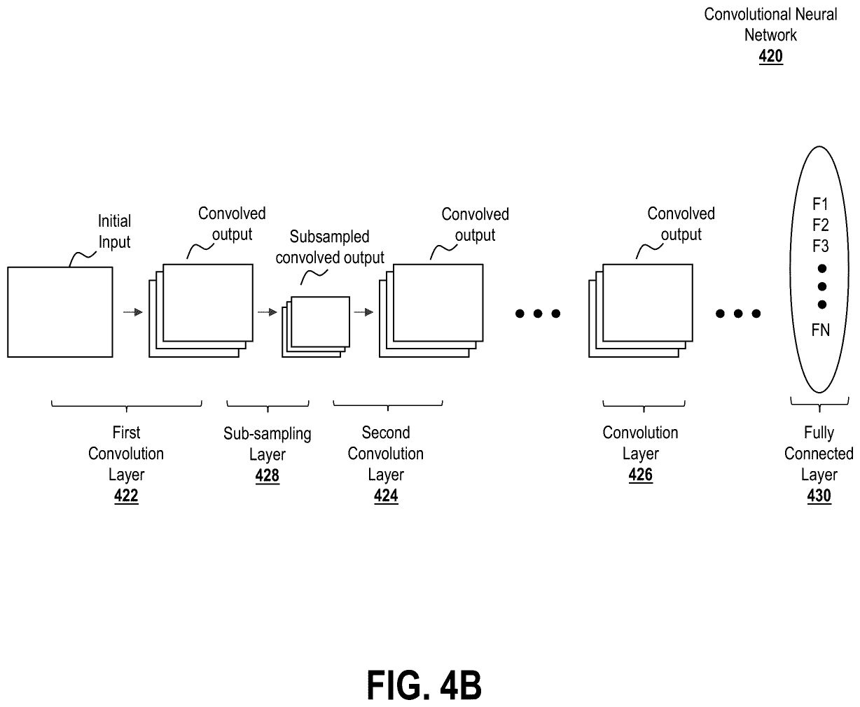

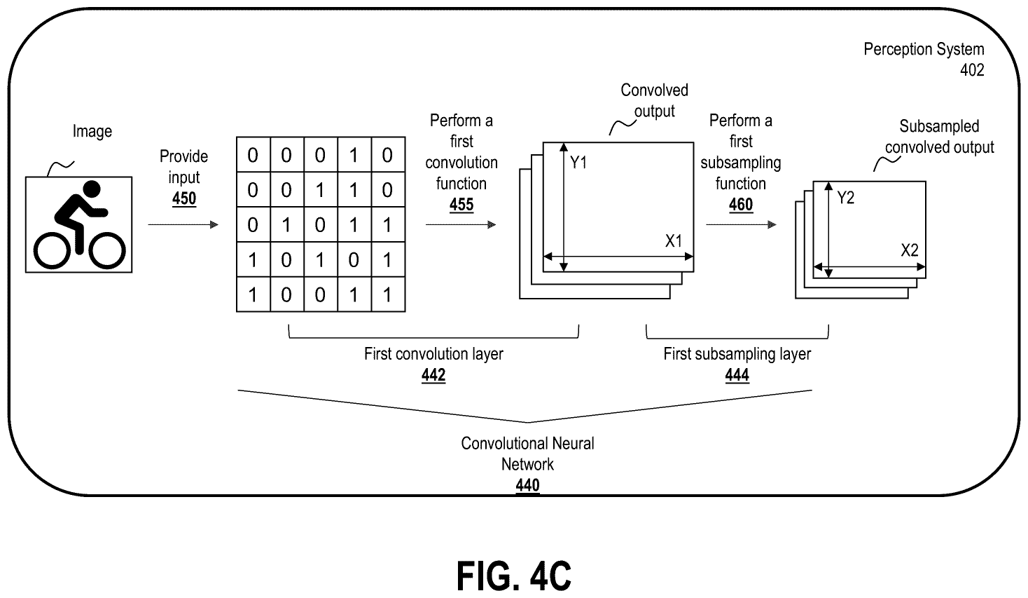

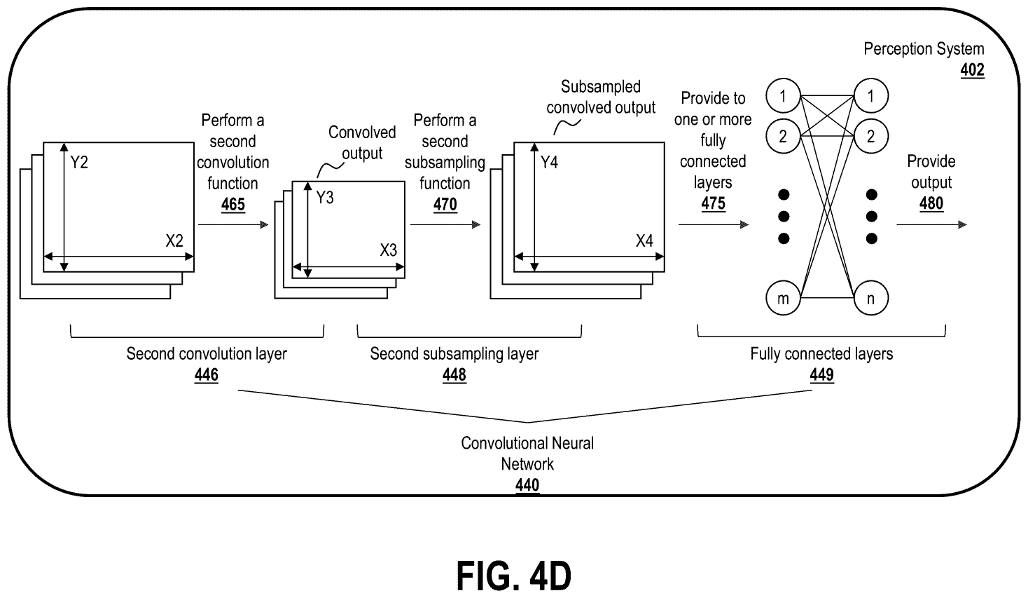

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Inference System

Autonomous vehicles plan vehicle trajectories and execute control instructions to operate the autonomous vehicles to follow the vehicle trajectories. For instance, autonomous vehicles may determine whether vehicle trajectories adhere to vehicle trajectory standards (e.g., sets of conditions for safe, comfortable, and/or legal requirements (such as speed limits), and the like, for operation of an autonomous vehicle).

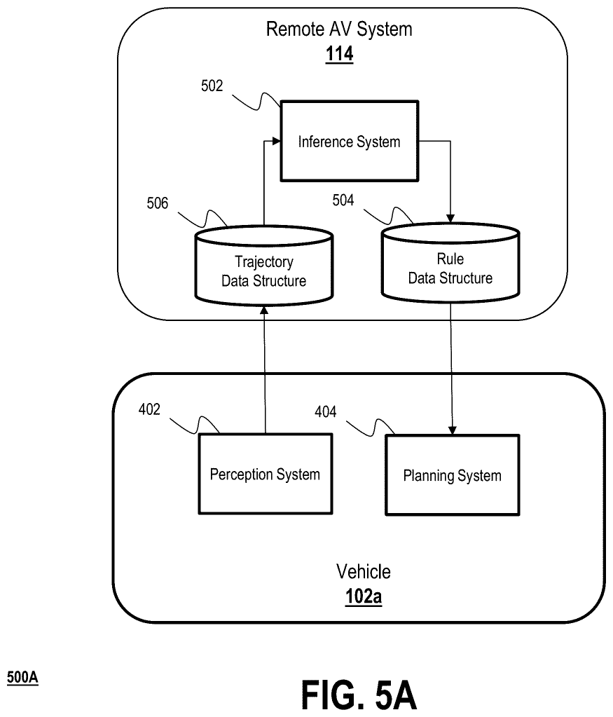

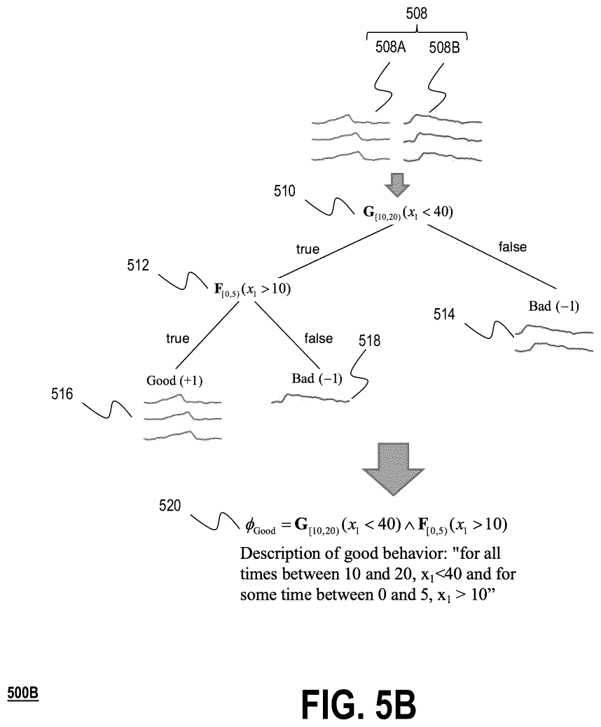

FIG. 5A is a block diagram illustrating an example environment 500A in which an inference system 502 infers vehicle trajectory standards. The environment 500A includes the remote AV system 114 and an autonomous vehicle, such as vehicle 102a, in communication. In particular, the perception system 402 tracks (e.g., monitors and obtains), stores, and provides trajectory data to the remote AV system 114. The remote AV system 114 stores the trajectory data in a trajectory data structure 506. The inference system 502 retrieves particular trajectory data and infers vehicle trajectory standards. The inference system 502 may then store the vehicle trajectory standards in a rule data structure 504 and/or provide the vehicle trajectory standards to the planning system 404 of the vehicle 102a. The planning system 404 may use the vehicle trajectory standards to select vehicle trajectories to plan and navigate the vehicle 102a.

In some cases, the perception system 402 may track (e.g., monitor and obtain) the trajectory data while the autonomous vehicle 102s maneuvers through an environment. For instance, the perception system 402 may track the trajectory data on a continuous basis (e.g., for every unit of time or distance traveled), for each trip between locations, for each autonomous vehicle action, and the like. In some cases, the trajectory data may include a vehicle state over time and/or environmental relation over time. In some cases, the vehicle state over time may include location, speed or velocity, acceleration, jerk (change of acceleration over time), orientation (e.g., heading), and the like, indexed to timestamps or locations. The environmental relation over time may distance to other objects (e.g., other vehicles, pedestrians, and the like) or distance to environmental constraints (e.g., edges of lanes or curbs, stop signs, stop lights, and the like), indexed to timestamps or locations. In this manner, trajectory data may be tracked and reported to inform the inference system 502.

In some cases, the perception system 402 may associate the trajectory data to particular autonomous vehicle actions. For instance, the perception system 402 may associate trajectory data for a trip to actions taken during the trip. In some cases, the perception system 402 may segment the trajectory data for a trip (or some sub-part thereof) and label the segments in accordance with autonomous vehicle actions taken during the trip (or the sub-part of the trip). As an example, the planning system 404 may determine a particular autonomous vehicle action (e.g., maintain course, change lanes, turn right/left onto different street, stop at stop sign, stop at stop light, yield for pedestrian, and the like) and the perception system 402 may label corresponding trajectory data with the autonomous vehicle action taken. In this manner, trajectory data may catalog different autonomous vehicle actions and associate the actions with trajectory data that resulted from taking the autonomous vehicle action.

In some cases, the perception system 402 may obtain the vehicle state over time from the localization system 406. In some cases, the perception system 402 may obtain the environmental relation over time based on output from sensors of the perception system 402 (e.g., cameras 202a, LiDAR sensors 202b, and/or the radar sensors 202c) and/or from the vehicle state with respect a map of the environment.

In some cases, the perception system 402 may receive a user input (referred to as “annotations” herein) indicating an aspect of a particular segment or vehicle action. For instance, the user input may indicate whether the segment or vehicle action was acceptable or not acceptable, comfortable or not, felt dangerous or not, and the like (generally, a “user experience” of the segment or vehicle action). As an example, the perception system 402 may be connected to a user device (e.g., via wired or wireless communication) and the user device may provide a user interface for a user to input the annotation regarding segments or vehicle actions. In some cases, the user device may be a part of autonomous vehicle 102a or a personal computing device of the user (e.g., a mobile device, a laptop, a computer, and the like). The perception system 402 may then label the segment or vehicle action with the annotation. In some cases, the annotations may be a part of trajectory data or separate from the trajectory data. In this manner, the perception system 402 may obtain and store user experiences of segments and/or vehicle actions.

In some cases, the perception system 402 may store and report the trajectory data (as segmented and/or annotated) to the remote AV system 114. For instance, the perception system 402 may report the trajectory data continuously (e.g., every set period of time or distance traveled), for each trip between locations, for each autonomous vehicle action, and the like. In this manner, the perception system 402 may offload the trajectory data and preserve memory onboard the autonomous vehicle 102a.

In some cases, the remote AV system 114 stores the trajectory data in the trajectory data structure 506. For instance, the remote AV system 114 may store the trajectory data in the trajectory data structure 506 as the trajectory data is received from autonomous vehicles, including autonomous vehicle 102a. The remote AV system 114 may store the trajectory data as records in the trajectory data structure 506. For instance, the trajectory data structure 506 may be a relational data structure (e.g., a database of records) or non-relational data structure (e.g., a data lake of records). In some cases, each record may include trajectory data as reported. In some cases, each record may include trajectory data for a particular autonomous vehicle. In some cases, each record may include trajectory data for a segment or vehicle action.

In some cases, the remote AV system 114 stores trajectory data from simulations in the trajectory data structure 506. In some such cases, the trajectory data may include simulated vehicle state over time and/or simulated environmental relation over time for a particular simulation of an autonomous vehicle in a simulated environment. For instance, the remote AV system 114 (or a simulation system) may perform simulations of vehicle actions in the simulated environments to test and/or confirm any changes in software and/or hardware of autonomous vehicles. In this case, the remote AV system 114 may obtain the trajectory data from the simulation (e.g., from the simulation system) and store the trajectory data in the trajectory data structure 506. The remote AV system 114 may label segments of the trajectory data in accordance the vehicle actions simulated (e.g., based on timestamps and/or locations in the simulation). In some cases, trajectory data from simulations may be stored with a label indicating it is from a simulation.

In some cases, the remote AV system 114 (or the simulation system) may determine whether the trajectory data satisfies at least one safety threshold. The at least one safety threshold may include a distance threshold to simulated objects or simulated environment (e.g., a minimum distance from a simulated object, etc.), a collision threshold with simulated objects or simulated environment (e.g., whether a collision would occur or is likely to occur, etc.), and the like. The remote AV system 114 may determine the at least one safety threshold is not satisfied when a location of the simulated vehicle is within the at least one distance threshold of any simulated object or simulated environment. If the remote AV system 114 determines the trajectory data satisfies all of the at least one safety threshold, the remote AV system 114 may determine an annotation for the trajectory data that indicates the trajectory data as acceptable (e.g., not dangerous). If the remote AV system 114 determines the trajectory data does not satisfy any of the at least one safety threshold, the remote AV system 114 may determine an annotation for the trajectory data that indicates the trajectory data as not acceptable (e.g., dangerous).

In some cases, the inference system 502 retrieves particular trajectory data and infers vehicle trajectory standards. For instance, the inference system 502 may receive an instruction to determine a vehicle trajectory standard for an autonomous vehicle action (e.g., maintain course, change lanes, turn right/left onto different street, stop at stop sign, stop at stop light, yield for pedestrian, and the like). As an example, the inference system 502 may receive the instruction from a user device associated with a user of the inference system 502 (e.g., an engineer or administrator). The inference system 502 may then retrieve particular trajectory data from the trajectory data structure 506 in accordance with the instruction. For instance, the inference system 502 may determine whether any records contain trajectory data for the autonomous vehicle action and retrieve the records that contain trajectory data for the autonomous vehicle action. To determine a record contains trajectory data for the autonomous vehicle action, the inference system 502 may determine whether the record has labeled segments (e.g., at least one segment) that match the autonomous vehicle action. If the record has labeled segments that match, the inference system 502 may return the matching record. If the record does not have labeled segments that match, the inference system 502 may not return the record.

In some cases, the inference system 502 may determine whether the retrieved records satisfy a generation threshold. The generation threshold may be a preset number to generate a decision tree. For instance, the preset number may be one hundred records, one thousand records, and the like. If the inference system 502 determines the retrieved records satisfy the generation threshold, the inference system 502 may proceed to generate a decision tree. If the inference system 502 determines the retrieved records do not satisfy the generation threshold, the inference system 502 may proceed to not generate a decision tree and inform the user device (e.g., the user) that the trajectory data structure 506 has records less than the generation threshold.

In some cases, the retrieved records may be a training dataset associated with the autonomous vehicle action. In this case, the training dataset may include trajectory data for a plurality of examples of the autonomous vehicle action and labels for each of the plurality of examples. For instance, each segment of the retrieved records that corresponds to the autonomous vehicle action may be an example and the label of the segment may be a label for the example. In this manner, the retrieved records may form the training dataset of examples.

In some cases, to infer the vehicle trajectory standard, the inference system 502 may generate a decision tree based on the trajectory data and the labels of the training dataset and determine the vehicle trajectory standard based on the decision tree. For instance, the inference system 502 may use conditions (e.g., formulas), at every node, to split traces of the training data. Each trace may correspond to a particular segment of the training data, and each trace may have a label. The inference system 502 may split the traces by selecting a first group of traces based on a condition and associating the first group with a first child node from a root node. The inference system 502 may associate a second group of traces that did not satisfy the condition with a second child node from the root node. The inference system 502 may evaluate the conditions on values of parameters of a trace. The parameters of the trace may include components of the vehicle state over time and/or environmental relation over time, such as a vehicle trajectory (e.g., a shape of the location with respect to time), speed, acceleration, jerk, distance to an object, and the like. The values of a parameter may be data from trajectory data corresponding to parameter (e.g., values of components of the vehicle state over time and/or environmental relation over time).

In some cases, each condition may include at least one conditional operator and at least one variable to evaluate one or more parameters. Thus, each condition may be associated with a set of parameters. For instance, a first condition may be associated with location, a second condition may be associated with speed, a third condition may be associated with acceleration, a fourth condition may be associated with heading, and the like, for each parameter or combinations of parameters.

In some cases, the at least one conditional operator may be one or combinations of “greater than,” “greater than or equal to,” “less than,” “less than or equal to,” “equal to,” “and,” “or,” “nand,” “nor,” and the like. The at least one variable may be a threshold value and/or a sampling range. The threshold value a real-valued number to evaluate a parameter in accordance with the at least one condition operator. The sampling range may be a range indicating a portion of a trace (e.g., time or distance from a start to an end, or points therebetween). Thus, each condition may be an arbitrarily complex condition to evaluate one or more parameters of traces to determine whether the condition is true or not for a particular trace. In some cases, conditions may be restricted to only one parameter (e.g., to evaluate a single parameter of a trace, referred to as threshold conditions or range conditions).

In some cases, the conditions may be of different types. For instance, a first type of condition may determine whether any value of parameter within the sampling range causes the condition to evaluate to true (or not). A second type of condition may determine whether all values of parameter within the sampling range causes the condition to evaluate to true (or not).

In some cases, the inference system 502 may adjust the least one variable and/or the at least one operator for a condition. For instance, the inference system 502 may adjust the least one variable and/or the at least one operator for the condition based on a set of traces associated with a node. In some case, the inference system 502 may adjust the least one variable by adjusting the threshold value and/or the sampling range (e.g., one or both of the end points of the range, inclusive or exclusive endpoints). In some cases, the inference system 502 may adjust the at least one operator to a different conditional operator (e.g., greater than to less than, and the like). In some cases, the inference system 502 may adjust the least one variable and/or the at least one operator to maximize a split of labels on a set of examples for the condition based on a set of traces associated with a node. As an example, for a condition, the inference system 502 may generate a plurality of sets of variables and operators for the condition (e.g., to generate a plurality of particular conditions for the one or more parameters associated with the condition), determine a score (e.g., an impurity reduction measure) for each set of variables and operations, and select a highest (or lowest) scored set of variables and operators as an adjusted at least one variable and/or adjusted at least one operator for the condition.

In some cases, the decision tree includes at least two levels. In some cases, the decision tree includes two levels, three levels, four levels, and the like. At least one condition may be associated with nodes at each level (e.g., each node of a level may be associated with a condition). The inference system 502 may sort the trajectory data into different groups at each level in accordance with the at least one condition at each level and traces associated with each node. The inference system 502 may associate the different groups with child nodes of each node at a next level.

Generally, each successive node (e.g., a child node to a node (referred to as a parent node)) may correspond to a level of the decision tree. In some cases, the root node may be in a first level of the decision tree, and a child of the root node may be in a second level of the decision tree with any same generation nodes (e.g., nodes in a same level and that may share a same parent node or different parent node but shared ancestor node (e.g., a grand-parent node, and the like).

In some cases, the inference system 502 may generate the decision tree using a predetermined condition at each node. In some cases, the inference system 502 may generate the decision tree for a predetermined number of nodes (e.g., root node, 1^{st} child node, 2^{nd} child node, and the like). In some cases, the inference system 502 may generate the decision tree for the predetermined number of nodes using the predetermined condition at each node. For instance, the predetermined conditions may be defined by a user (e.g., via user inputs on the user device) based on domain knowledge of the vehicle action the decision tree is representing. The predetermined number of nodes may be defined by a user (e.g., via user inputs on the user device) to ensure the decision tree is shallow (e.g., has no more than the predetermined number of nodes).

In some cases, the inference system 502 may select a condition for a node by ranking a plurality of conditions using an impurity reduction measure. The impurity reduction measure may quantify a quality of a split for that condition. The inference system 502 may then select a highest ranked condition as the condition for node. In successive child nodes, the inference system 502 may exclude from the ranking or modify any previously used conditions to not have a same at least one variable and/or a same at least one operator. For instance, the impurity reduction measure may be an information gain measure, a Gini gain measure, a misclassification gain measure, and the like. Generally, a good split may result in a group of traces that are “pure” (that is, contain objects of a same class).

In some cases, the inference system 502 may reclusively split successive child nodes until a continuation condition is not satisfied. The continuation condition may indicate a group of traces is not “pure” (that is, contains a mix of objects of different classes). For instance, the objects may be traces, and the classes may be labels of the traces. In some cases, the inference system 502 may determine the continuation condition is satisfied when traces of a group include traces labeled a first label (e.g., a positive example of an autonomous vehicle action, such as acceptable, comfortable, not dangerous, and the like) and traces labeled a second label (e.g., a negative example of the autonomous vehicle action, such as not acceptable, not comfortable, dangerous, and the like). In some cases, the inference system 502 may determine the continuation condition is not satisfied when traces of a group include only traces (or a threshold percentage of traces) labeled the first label. In response to the continuation condition being not satisfied, the inference system 502 may determine the decision tree is complete. In some cases, the inference system 5002 may use boosted decision tree generation to generate the decision trees.

In some cases, the inference system 502 may determine a sequence of connected nodes as a positive path for the decision tree. The sequence of connected nodes may start at the root node and follow each branch to a child node that groups traces evaluated as true for a condition of a node. In this manner, the inference system 502 may split training data for an autonomous vehicle action using conditions on values of parameters to group subsets of traces in a manner that increases a concentration of like labels (e.g., the first label) at each successive node.

In some cases, the inference system 502 may determine the vehicle trajectory standard by traversing a complete decision tree. For instance, the inference system 502 may traverse a positive path of the decision tree and retrieve each condition for each node along the positive path. In some cases, the vehicle trajectory standard may be constructed using signal temporal logic (STL) with the retrieved conditions from the nodes along the path. Thus, the vehicle trajectory standard may define a logic that is expressive enough for autonomous vehicle applications yet simple enough to make learning computationally feasible.

FIG. 5B is a diagram illustrating an example decision tree 500B to infer vehicle trajectory standards. The decision tree 500B starts at root node 510 associated with a training dataset 508. The training dataset 508 includes a plurality of examples of trajectory data, include positive examples of trajectory data 508A (indicated by corresponding labels) and negative examples of trajectory data 508B (indicated by corresponding labels). The inference system 502 may then generate the decision tree 500B, as discussed herein.

For instance, the inference system 502 may determine a first condition at the root node 510 from a set of conditions that satisfies a branching condition. In the case the first condition is predetermined, the inference system 502 may adjust the at least one conditional operator and/or the at least one variable of the first condition to increase the impurity reduction measure for the condition. In this case, the branching condition may be a threshold impurity reduction measure. In this manner, the inference system 502 may leverage domain knowledge as input by a user to reduce computations and/or reduce computation time. As an example, if an autonomous vehicle action is to stop, the first condition may be predetermined by a user to evaluate against deceleration (e.g., negative acceleration) or separation distance to an object (e.g., a stop sign or other object).

In the case the first condition is not predetermined, the inference system 502 may rank the set of conditions in accordance with their respective impurity reduction measures. In this case, the inference system 502 may select a highest-ranking condition and the inference system may determine the branching condition is satisfied when the first condition has the highest impurity reduction measure. In some cases, the inference system 502 may adjust each condition to increase its respective impurity reduction measure before ranking the set of conditions. In this manner, without domain knowledge, the inference system 502 may consider all combinations of parameters (e.g., alone or in different sets of combinations) in order to reduce impurity efficiently (e.g., with less computations).

The inference system 502 then branches the decision tree to a first node 512. The inference system 502 associates the root node 510 with the first condition and a first sub-set of traces of the set of traces that satisfy the first condition with the first node 512. In some cases, the inference system 502 may also associate a remaining sub-set of traces of the set of traces that do not satisfy the first condition with a different first node 514. In some cases, this may not be performed (e.g., to reduce computation or memory footprint).

The inference system 502 may then determine whether a continuation condition is satisfied. As discussed herein, the inference system 502 may determine the continuation condition is not satisfied when a set of traces associated with a node include traces with different labels (e.g., the first label and the second label). In some cases, the inference system 502 may determine the continuation condition is satisfied when a set of traces associated with a node include traces of a same label (e.g., the first label) or have a threshold percentage of traces of the same label.

The inference system 502 then, in response to determining the continuation condition is satisfied, can recursively, until the continuation condition is not satisfied, determine a second condition that satisfies the branching condition, branch the decision tree to second node 516, and associate the first node 512 with the second condition and a second sub-set of the first sub-set of traces that satisfy the second condition with the second node 516. In the case of decision tree 500B, the continuation condition is considered satisfied at the second node 516, as all traces associated therewith have a same label (e.g., the first label).

In some cases, the inference system 502 may determine the second condition in a similar manner as the first condition was determined. In some cases, the second condition may be predetermined and the inference system 502 may adjust the second condition to increase an impurity reduction measure for the second condition. In some cases, the second condition may not be predetermined and the inference system 502 may rank remaining conditions (e.g., of the set of conditions without the first condition, or the first condition modified to be different with different values and operators) with respect to the first sub-set of traces in accordance with their impurity reduction measures. In this manner, at each level along the positive path, remaining conditions may have different rankings, as the ranking are based on the set of traces associated with the particular node along the positive path. Thus, the inference system 502 may efficiently (e.g., with reduced computations) determine a final decision tree (e.g., a last child node that does not satisfy the continuation condition).

In some cases, the inference system 502 may also associate a remaining sub-set of traces of the first sub-set of traces that do not satisfy the second condition with a different second node 518. In some cases, this may not be performed (e.g., to reduce computation or memory footprint).

In some cases, to determine an impurity reduction measure for a condition at a node associated with traces, the inference system 502 may determine a first set of traces that satisfy the condition and a second set of traces that do not satisfy the condition and determine the impurity reduction measure based on the first set of traces and the second set of traces. For instance,_.

In some cases, to determine the vehicle trajectory standard 520 based on the decision tree, the inference system 502 determines the vehicle trajectory standard 520 by traversing nodes of the decision tree and joining conditions associated with traversed nodes. For instance, in decision tree 500B, the inference system 502 may traverse the positive path connecting root node 510 to first node 512, and finally to the second node 516. As the root node 510 is associated with the first condition and first node 512 is associated with the second condition, the inference system 502 may join the first condition with the second condition to form the vehicle trajectory standard 520. As second node 516 is associated with a continuation threshold being not satisfied, the second node 516 may not be associated with a condition. In some cases, the different second node 518 and the different first node 514 may not be associated with a condition, as the different second node 518 and the different first node 514 may not be on a positive path of the decision tree. Thus, additional processing to split respective sets of traces at the respective nodes may be omitted.

Returning to FIG. 5A, in some cases, the inference system 502 may then store the vehicle trajectory standards (e.g., vehicle trajectory standard 520) in a rule data structure 504 and/or provide the vehicle trajectory standards to the planning system 404 of the autonomous vehicles, such as vehicle 102a. The rule data structure 504 may be a relational data structure (e.g., a database) or non-relational data structure (e.g., a data lake). The rule data structure 504 may store vehicle trajectory standards in association with vehicle autonomous actions (e.g., a one-to-one mapping). The rule data structure 504 may store vehicle trajectory standards in associated with the trajectory data that they are based on (e.g., by copying the data or pointing to the data in the trajectory data structure 506). In some cases, the rule data structure 504 and the trajectory data structure 506 may be combined or separate.

In some cases, autonomous vehicles that reports trajectory data may be the same or different from autonomous vehicles that use vehicle trajectory standards. For instance, certain autonomous vehicles (e.g., mapping and/or test ride vehicles) may report trajectory data with annotations, while certain other autonomous vehicles (e.g., taxi and/or delivery vehicles) may use the vehicle trajectory standards. In some cases, the mapping and/or test ride vehicles may also use the vehicle trajectory standards. In some cases, the taxi and/or delivery vehicles may also report trajectory data with annotations.

In some cases, the planning system 404 may use the vehicle trajectory standards to select vehicle trajectories to plan and navigate the vehicle 102a. For instance, the planning system 404 may receive environment data associated with an environment of the autonomous vehicle 102a and determine a plurality of trajectories for an autonomous vehicle action based on the environment data.

In some cases, to receive the environmental data, the planning system 404 may receive location data and map data from the localization system 406 and/or object data from the perception system 402. The location data may indicate a current location on a map and the map data may indicate near by (e.g., within a threshold distance) objects, such as map features indicating lane or other environmental objects to avoid, and traffic control features, such as direction of traffic, speed limits, and the like. The object data may indicate location, speed, heading and the like of other objects sensed by the sensors of the autonomous vehicle (e.g., cameras 202a, LiDAR sensors 202b, and/or radar sensors 202c).

In some cases, to determine the plurality of trajectories, the planning system 404 may generate the plurality of trajectories (e.g., in accordance with various generation methodologies to avoid objects, stay in an operating environment (e.g., a lane), and proceed from a starting location to a destination location). For instance, the planning system 404 may generate the plurality of trajectories based on the location data, the map data, and the object data. In some cases, the planning system 404 may determine an autonomous vehicle action as a part of generating the plurality of trajectories. The autonomous vehicle action may be one of maintain course (e.g., stay in current lane), change lanes, turn right/left onto a different street, stop at stop sign, stop at stop light, yield for pedestrian, and the like.

In some cases, the planning system 404 may select a trajectory of the plurality of trajectories for the autonomous vehicle based on a vehicle trajectory standard associated with the autonomous vehicle action. As discussed herein, the vehicle trajectory standard may be generated based on a decision tree, where the decision tree is generated from trajectory data of a plurality of example trajectories, and the plurality of example trajectories are associated with the autonomous vehicle action. The planning system 404 may then control the autonomous vehicle 102a based on the selected trajectory by, e.g., passing instructions and/or the selected trajectory to the control system 408. The control system 408 may then determine instructions (if not provided) based on the selected trajectory and execute actuation commands via the DBW system 202h, in accordance with the provided instruction or determined instructions.

In some cases, the planning system 404 may select an initial trajectory from a plurality of trajectories, where the initial trajectory satisfies the vehicle trajectory standard. For instance, the planning system 404 may evaluate the plurality of trajectories using the vehicle trajectory standard to determine whether none, some, or all of the vehicle trajectory standard satisfy the vehicle trajectory standard. Of the plurality of trajectories that satisfy the vehicle trajectory standard, the planning system 404 may select one as the initial trajectory. For instance, the planning system 404 may select one of the plurality of trajectories that satisfy the vehicle trajectory standard based on other vehicle trajectory standards being satisfied, a distance traveled, or time taken to traverse a trajectory, and the like (generally referred to as selection criteria).

In some cases, the planning system 404 may select an initial trajectory from a plurality of trajectories by: determining the initial trajectory (e.g., in accordance with the various generation methodologies) and determine the initial trajectory does not satisfy the vehicle trajectory standard. In this case, the planning system 404 may modify the initial trajectory until the initial trajectory satisfies the vehicle trajectory standard. In some cases, the planning system 404 may randomly cause changes to the initial trajectory (e.g., in accordance with the various generation methodologies) and determine whether the initial trajectory (as modified) satisfies the vehicle trajectory standard. In some cases, the planning system 404 may input values (based on the vehicle trajectory standard) to the various generation methodologies to cause changes to the initial trajectory and determine whether the initial trajectory (as modified) satisfies the vehicle trajectory standard. For instance, certain or all of the generation methodologies may take as input additional constraints to be used in the trajectory generation.

In some cases, the planning system 404 may select an initial trajectory from a plurality of trajectories by: determining the initial trajectory by inputting values (based on the vehicle trajectory standard) to the various generation methodologies to generate the initial trajectory and determine whether the initial trajectory satisfies the vehicle trajectory standard. For instance, some or all of the generation methodologies may consider the additional constraints as fixed constraints, while some or all of the generation methodologies may consider the additional constraints as flexible constraints (and thus deviate from additional constraints). In the case of a generation methodology considering the additional constraints as fixed constraints, the planning system 404 may confirm adherence by confirming the vehicle trajectory standard is satisfied. In the case of a generation methodology considering the additional constraints as flexible constraints, the planning system 404 may confirm the generated trajectory satisfies the vehicle trajectory standard.

In some cases, the vehicle trajectory standard may be one of a plurality of vehicle trajectory standards. In some cases, each of the plurality of vehicle trajectory standards may be associated with at least one autonomous vehicle action.

In some cases, to select the trajectory of the plurality of trajectories, the planning system 404 may determine a set of vehicle trajectory standards associated with the autonomous vehicle action and select the trajectory from the plurality of trajectories that satisfies each of the set of vehicle trajectory standards. For instance, the planning system 404 may determine the set of set of vehicle trajectory standards by retrieving each vehicle trajectory standard associated with the particular autonomous vehicle action. To select the trajectory from the plurality of trajectories that satisfies each of the set of vehicle trajectory standards, the planning system 404 may evaluate each trajectory using each vehicle trajectory standard and determine which trajectory (if any) that satisfies each of the set of vehicle trajectory standards. In some cases, the planning system 404 may check each trajectory (against each vehicle trajectory standard) in parallel and, if a trajectory does not satisfy a vehicle trajectory standard, that trajectory may be removed from consideration. In some cases, the planning system 404 may check each vehicle trajectory standard (against each trajectory) in parallel and only those trajectories that pass each parallel check may be considered. In this manner, the planning system 404 may determine whether any trajectory satisfies all of the vehicle trajectory standards. Of the set of trajectories that satisfy all of the vehicle trajectory standards, the planning system 404 may select one trajectory, e.g., based on the selection criteria.

In some cases, the planning system 404 may store evaluation results in, e.g., a matrix of results. The matrix of results may associate each result (satisfied or not) with a trajectory and a vehicle trajectory standard.

In some cases, the planning system may select a trajectory that satisfies the largest number of vehicle trajectory standards. For instance, if no trajectory satisfies all of the vehicle trajectory standards, the planning system 404 may then select the trajectory that satisfies the largest number of vehicle trajectory standards. In some cases, the planning system 404 may evaluate all of the trajectories against all of the vehicle trajectory standards, as discussed herein. In some cases, the planning system 404 may retrieve the matrix of results. The planning system 404 may then determine, for each trajectory, a number of vehicle trajectory standards that are satisfied by the trajectory. For instance, the planning system 404 may count a number of entries in the matrix of results that indicate the trajectory satisfied a corresponding vehicle trajectory standard. The planning system 404 may then select a trajectory with the largest number of standards satisfied. In the case of a tie (e.g., two or more trajectories have a same largest number of satisfied vehicle trajectory standards that are satisfied), the planning system 404 may select one of the tying trajectories in accordance with the selection criteria.

In some cases, the planning system 404 may select a trajectory in accordance with prioritization of vehicle trajectory standards. For instance, after determining the set of vehicle trajectory standards, the planning system may determine a prioritization of the set of vehicle trajectory standards in accordance with a priority policy. The priority policy may prioritize vehicle trajectory standards associated with safety over vehicle trajectory standards associated with comfort or vehicle trajectory standards associated with signaling driving intent, and the like. Thus, the planning system 404 may prioritize a first vehicle trajectory standard over a second vehicle trajectory standard by selecting a trajectory that satisfies the first vehicle trajectory standard and not the second vehicle trajectory standard instead of selecting a trajectory that satisfies the second vehicle trajectory standard and not the first vehicle trajectory standard. For instance, if no trajectory satisfies all of the vehicle trajectory standards, the planning system 404 may first select a trajectory that satisfies prioritized vehicle trajectory standards and, only in the case that the prioritized vehicle trajectory standards are not satisfied by any trajectory, select a trajectory that satisfies lesser priority vehicle trajectory standards.

In some cases, the planning system 404 (or the perception system 402, as discussed herein) may receive an annotation from a user device after controlling the autonomous vehicle based on the selected trajectory. The planning system 404 may then report the annotation with trajectory data associated with the selected trajectory to the remote AV system 114. In this manner, the planning system 404 may provide the annotation indicating a user experience of the selected trajectory. Thus, the systems and methods of the present disclosure may provide feedback for future adjustment of existing vehicle trajectory standards associated with the autonomous vehicle action.

### Example Flow Diagrams of Inference System

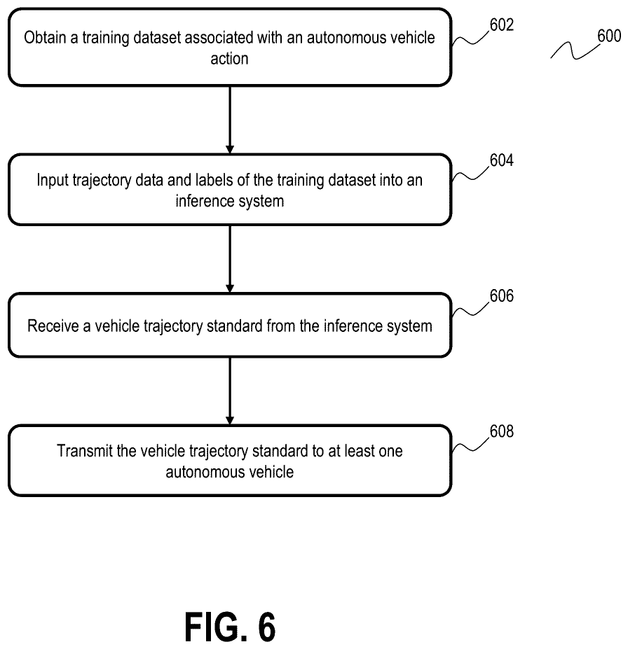

FIG. 6 is a flow diagram illustrating an example of a routine 600 implemented by one or more processors to infer vehicle trajectory standards. The flow diagram illustrated in FIG. 6 is provided for illustrative purposes only. It will be understood that one or more of the steps of the routine 600 illustrated in FIG. 6 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 602, the remote AV system 114 obtains a training dataset associated with an autonomous vehicle action. In some cases, the training dataset may include trajectory data for a plurality of examples of the autonomous vehicle action and labels for each of the plurality of examples. For instance, the remote AV system 114 may retrieve particular trajectory data from the trajectory data structure 506 in accordance with an instruction, as discussed herein.

At block 604, the remote AV system 114 inputs the trajectory data and the labels of the training dataset into the inference system 502. In some cases, the inference system 502 may be configured to output a vehicle trajectory standard in accordance with a decision tree generated based on the trajectory data and the labels of the training dataset. For instance, the remote AV system 114 may, using the inference system 502, generate the decision tree by splitting traces in accordance with conditions, and determine the vehicle trajectory standard by traversing the decision tree, as discussed herein. At block 606, the remote AV system 114 receives the vehicle trajectory standard from the inference system 502.

At block 608, the remote AV system 114 transmits the vehicle trajectory standard to at least one autonomous vehicle. In some cases, the at least one autonomous vehicle may use the vehicle trajectory standard to plan trajectories and/or control actions associated with the autonomous vehicle action. For instance, the remote AV system 114 may store the vehicle trajectory standard in the rule data structure 504 and transmit the vehicle trajectory standard to planning systems 404 of autonomous vehicles, as discussed herein.

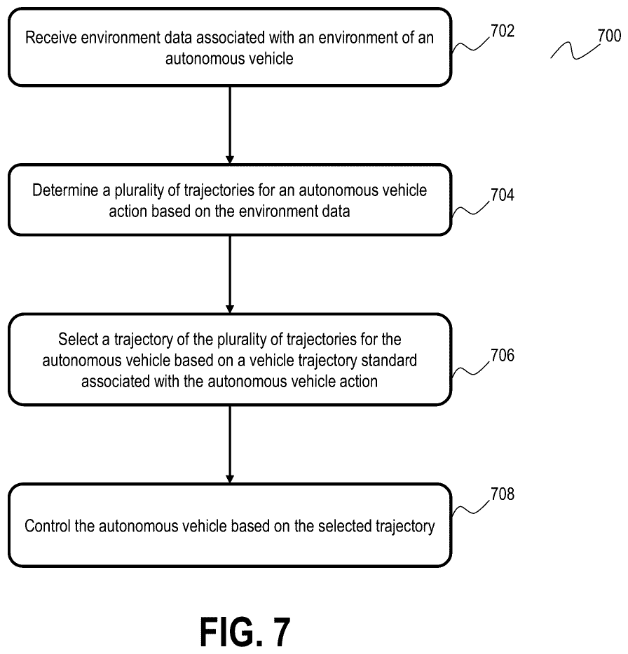

FIG. 7 is a flow diagram illustrating an example of a routine implemented by one or more processors to select a vehicle trajectory based on a vehicle trajectory standard. The flow diagram illustrated in FIG. 7 is provided for illustrative purposes only. It will be understood that one or more of the steps of the routine 700 illustrated in FIG. 7 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 702, the planning system 404 receives environment data associated with an environment of an autonomous vehicle. For instance, the planning system 404 may receive the location data, map data, and the object data, as discussed herein.

At block 704, the planning system 404 determines a plurality of trajectories for an autonomous vehicle action based on the environment data. For instance, the planning system 404 may generate the plurality of trajectories based on the location data, the map data, and the object data, as discussed herein.

At block 706, the planning system 404 selects a trajectory of the plurality of trajectories for the autonomous vehicle based on a vehicle trajectory standard associated with the autonomous vehicle action. In some cases, the vehicle trajectory standard is generated based on a decision tree, the decision tree is generated from trajectory data of a plurality of example trajectories, and the plurality of example trajectories are associated with the autonomous vehicle action. For instance, the planning system 404 may select the trajectory in accordance with one or more of a plurality of vehicle trajectory standards, as discussed herein.

At block 708, the planning system 404 controls the autonomous vehicle based on the selected trajectory. For instance, the planning system 404 may pass the selected trajectory and/or instructions based on the selected trajectory to the control system 408, as discussed herein, and the control system 408 may actuate various components of the vehicle 102a in accordance therewith.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

### EXAMPLES

Various example embodiments of the disclosure can be described by the following clauses:

Clause 1. A method, comprising: obtaining a training dataset associated with an autonomous vehicle action, the training dataset comprising trajectory data for a plurality of examples of the autonomous vehicle action and labels for each of the plurality of examples; generating a decision tree based on the trajectory data and the labels of the training dataset; determining a vehicle trajectory standard based on the decision tree; and communicating the vehicle trajectory standard to at least one autonomous vehicle, wherein the at least one autonomous vehicle uses the vehicle trajectory standard to select a vehicle trajectory for the at least one autonomous vehicle.

Clause 2. The method of clause 1, wherein obtaining the training dataset associated with the autonomous vehicle action comprises: obtaining first trajectory data associated with a first example of the autonomous vehicle action; obtaining a first label for the first example of the autonomous vehicle action; and associating the first label with the first trajectory data.

Clause 3. The method of clause 2, wherein obtaining the first label for the first example of the autonomous vehicle action comprises receiving an annotation from a user device, and wherein the annotation indicates a user experience of the first example of the autonomous vehicle action.

Clause 4. The method of clause 2, wherein obtaining the first label for the first example of the autonomous vehicle action comprises receiving an annotation from a simulation system, and wherein the simulation system determines the annotation based on the first trajectory data satisfying at least one safety threshold.

Clause 5. The method of any of clauses 1-4, wherein generating the decision tree based on the trajectory data and the labels of the training dataset comprises: receiving the trajectory data and the labels at a root node of the decision tree, the trajectory data comprising a set of traces that each correspond to a label and an example; determining a first condition from a set of conditions that satisfies a branching condition; branching the decision tree to a first node; associating the root node with the first condition and a first sub-set of traces of the set of traces that satisfy the first condition with the first node; determining a continuation condition is satisfied; and in response to determining the continuation condition is satisfied, recursively, until the continuation condition is not satisfied, determining a second condition that satisfies the branching condition, branching the decision tree to second node, and associating the first node with the second condition and a second sub-set of the first sub-set of traces that satisfy the second condition with the second node.

Clause 6. The method of clause 5, wherein the branching condition is satisfied when the first condition has a highest impurity reduction measure.

Clause 7. The method of clause 5, wherein determining the first condition from the set of conditions that satisfies the branching condition comprises: determining an impurity reduction measure for each condition of the set of conditions; and selecting the first condition based on the first condition having a highest impurity reduction measure.

Clause 8. The method of clause 7, wherein determining the impurity reduction measure for each condition of the set of conditions comprises, for each condition: determining a first set of traces that satisfy the condition and a second set of traces that do not satisfy the condition; and determining the impurity reduction measure based on the first set of traces and the second set of traces.

Clause 9. The method of clause 7, wherein the impurity reduction measure is at least one of an information gain, a Gini gain, or a misclassification gain.

Clause 10. The method of clause 5, wherein the set of conditions comprise different types of conditions, and wherein each condition comprises at least one conditional operator and at least one variable.

Clause 11. The method of clause 10, wherein the least one variable is adjusted based on the set of traces.

Clause 12. The method of clause 5, wherein the continuation condition is satisfied when a sub-set of the set of traces that satisfy the second condition contains only positively labeled traces.

Clause 13. The method of clause 5, wherein determining the vehicle trajectory standard based on the decision tree comprises: determining the vehicle trajectory standard by traversing nodes of the decision tree and joining conditions associated with traversed nodes.

Clause 14. The method of any of clauses 1-13, wherein the decision tree comprises at least two levels and at least one condition at each level of the at least two levels.

Clause 15. The method of clause 14, wherein each level of the at least two levels sorts the trajectory data into different groups in accordance with the at least one condition at each level.

Clause 16. The method of any of clauses 1-15, wherein the at least one autonomous vehicle uses the vehicle trajectory standard to select the vehicle trajectory for the at least one autonomous vehicle by selecting an initial trajectory from a plurality of trajectories, wherein the initial trajectory satisfies the vehicle trajectory standard.

Clause 17. The method of any of clauses 1-16, wherein the at least one autonomous vehicle uses the vehicle trajectory standard to select the vehicle trajectory for the at least one autonomous vehicle by: determining an initial trajectory; determining the initial trajectory does not satisfy the vehicle trajectory standard; and modifying the initial trajectory until the initial trajectory satisfies the vehicle trajectory standard.

Clause 18. A system, comprising: at least one processor, and at least one non-transitory storage media storing instructions that, when executed by the at least one processor, cause the at least one processor to: obtain a training dataset associated with an autonomous vehicle action, the training dataset comprising trajectory data for a plurality of examples of the autonomous vehicle action and labels for each of the plurality of examples; generate a decision tree based on the trajectory data and the labels of the training dataset; determine a vehicle trajectory standard based on the decision tree; and communicate the vehicle trajectory standard to at least one autonomous vehicle, wherein the at least one autonomous vehicle uses the vehicle trajectory standard to select a vehicle trajectory for the at least one autonomous vehicle.

Clause 19. The system of clause 18, wherein generating the decision tree based on the trajectory data and the labels of the training dataset comprises: receiving the trajectory data and the labels at a root node of the decision tree, the trajectory data comprising a set of traces that each correspond to a label and an example; determining a first condition from a set of conditions that satisfies a branching condition; branching the decision tree to a first node; associating the root node with the first condition and a first sub-set of traces of the set of traces that satisfy the first condition with the first node; determining a continuation condition is satisfied; and in response to determining the continuation condition is satisfied, recursively, until the continuation condition is not satisfied, determining a second condition that satisfies the branching condition, branching the decision tree to second node, and associating the first node with the second condition and a second sub-set of the first sub-set of traces that satisfy the second condition with the second node.

Clause 20. At least one non-transitory storage media storing instructions that, when executed by at least one processor, cause the at least one processor to: obtain a training dataset associated with an autonomous vehicle action, the training dataset comprising trajectory data for a plurality of examples of the autonomous vehicle action and labels for each of the plurality of examples; generate a decision tree based on the trajectory data and the labels of the training dataset; determine a vehicle trajectory standard based on the decision tree; and communicate the vehicle trajectory standard to at least one autonomous vehicle, wherein the at least one autonomous vehicle uses the vehicle trajectory standard to select a vehicle trajectory for the at least one autonomous vehicle.

Clause 21. A method, comprising: receiving environment data associated with an environment of an autonomous vehicle; determining a plurality of trajectories for an autonomous vehicle action based on the environment data; selecting a trajectory of the plurality of trajectories for the autonomous vehicle based on a vehicle trajectory standard associated with the autonomous vehicle action, wherein the vehicle trajectory standard is generated based on a decision tree, wherein the decision tree is generated from trajectory data of a plurality of example trajectories, wherein the plurality of example trajectories are associated with the autonomous vehicle action; and controlling the autonomous vehicle based on the selected trajectory.

Clause 22. The method of clause 21, wherein selecting the trajectory of the plurality of trajectories for the autonomous vehicle based on the vehicle trajectory standard associated with the autonomous vehicle action includes: selecting the trajectory from the plurality of trajectories, wherein the trajectory satisfies the vehicle trajectory standard.

Clause 23. The method of clause 21, wherein selecting the trajectory of the plurality of trajectories for the autonomous vehicle based on the vehicle trajectory standard associated with the autonomous vehicle action includes: selecting the trajectory from the plurality of trajectories; determining the trajectory does not satisfy the vehicle trajectory standard; and modifying the trajectory until the trajectory satisfies the vehicle trajectory standard.

Clause 24. The method of clause 21, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; and selecting the trajectory from the plurality of trajectories, wherein the trajectory satisfies each of the set of vehicle trajectory standards.

Clause 25. The method of clause 21, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; and selecting the trajectory from the plurality of trajectories, wherein the trajectory satisfies a largest number of the set of vehicle trajectory standards.

Clause 26. The method of clause 21, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; determining a prioritization of the set of vehicle trajectory standards in accordance with a priority policy, wherein a first vehicle trajectory standard is prioritized over a second vehicle trajectory standard; selecting a first trajectory from the plurality of trajectories; determining the first trajectory does not satisfy each the set of vehicle trajectory standards; and selecting a second trajectory from the plurality of trajectories, wherein the second trajectory satisfies the first vehicle trajectory standard but does not satisfy the second vehicle trajectory standard, wherein the second trajectory is the trajectory.

Clause 27. The method of any of clauses 21-26, further comprising, after controlling the autonomous vehicle based on the selected trajectory: receiving an annotation from a user device; and reporting the annotation with new trajectory data associated with the selected trajectory to a remote system, wherein the annotation indicates a user experience of the selected trajectory.

Clause 28. A system, comprising: at least one processor, and at least one non-transitory storage media storing instructions that, when executed by the at least one processor, cause the at least one processor to: receive environment data associated with an environment of an autonomous vehicle; determine a plurality of trajectories for an autonomous vehicle action based on the environment data; select a trajectory of the plurality of trajectories for the autonomous vehicle based on a vehicle trajectory standard associated with the autonomous vehicle action, wherein the vehicle trajectory standard is generated based on a decision tree, wherein the decision tree is generated from trajectory data of a plurality of example trajectories, wherein the plurality of example trajectories are associated with the autonomous vehicle action; and control the autonomous vehicle based on the selected trajectory.

Clause 29. The system of clause 28, wherein selecting the trajectory of the plurality of trajectories for the autonomous vehicle based on the vehicle trajectory standard associated with the autonomous vehicle action includes: selecting the trajectory from the plurality of trajectories, wherein the trajectory satisfies the vehicle trajectory standard.

Clause 30. The system of clause 28, wherein selecting the trajectory of the plurality of trajectories for the autonomous vehicle based on the vehicle trajectory standard associated with the autonomous vehicle action includes: selecting the trajectory from the plurality of trajectories; determining the trajectory does not satisfy the vehicle trajectory standard; and modifying the trajectory until the trajectory satisfies the vehicle trajectory standard.

Clause 31. The system of clause 28, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; and selecting the trajectory from the plurality of trajectories, wherein the trajectory satisfies each of the set of vehicle trajectory standards.

Clause 32. The system of clause 28, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; and selecting the trajectory from the plurality of trajectories, wherein the trajectory satisfies a largest number of the set of vehicle trajectory standards.

Clause 33. The system of clause 28, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; determining a prioritization of the set of vehicle trajectory standards in accordance with a priority policy, wherein a first vehicle trajectory standard is prioritized over a second vehicle trajectory standard; selecting a first trajectory from the plurality of trajectories; determining the first trajectory does not satisfy each the set of vehicle trajectory standards; and selecting a second trajectory from the plurality of trajectories, wherein the second trajectory satisfies the first vehicle trajectory standard but does not satisfy the second vehicle trajectory standard, wherein the second trajectory is the trajectory.

Clause 34. The system of any of clauses 28-33, further comprising, after controlling the autonomous vehicle based on the selected trajectory: receiving an annotation from a user device; and reporting the annotation with new trajectory data associated with the selected trajectory to a remote system, wherein the annotation indicates a user experience of the selected trajectory.

Clause 35. At least one non-transitory storage media storing instructions that, when executed by at least one processor, cause the at least one processor to: receive environment data associated with an environment of an autonomous vehicle; determine a plurality of trajectories for an autonomous vehicle action based on the environment data; select a trajectory of the plurality of trajectories for the autonomous vehicle based on a vehicle trajectory standard associated with the autonomous vehicle action, wherein the vehicle trajectory standard is generated based on a decision tree, wherein the decision tree is generated from trajectory data of a plurality of example trajectories, wherein the plurality of example trajectories are associated with the autonomous vehicle action; and control the autonomous vehicle based on the selected trajectory.

Clause 36. The least one non-transitory storage media of clause 35, wherein selecting the trajectory of the plurality of trajectories for the autonomous vehicle based on the vehicle trajectory standard associated with the autonomous vehicle action includes: selecting the trajectory from the plurality of trajectories, wherein the trajectory satisfies the vehicle trajectory standard.

Clause 37. The least one non-transitory storage media of clause 35, wherein selecting the trajectory of the plurality of trajectories for the autonomous vehicle based on the vehicle trajectory standard associated with the autonomous vehicle action includes: selecting the trajectory from the plurality of trajectories; determining the trajectory does not satisfy the vehicle trajectory standard; and modifying the trajectory until the trajectory satisfies the vehicle trajectory standard.

Clause 38. The least one non-transitory storage media of clause 35, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; and selecting the trajectory from the plurality of trajectories, wherein the trajectory satisfies each of the set of vehicle trajectory standards.

Clause 39. The least one non-transitory storage media of clause 35, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; and selecting the trajectory from the plurality of trajectories, wherein the trajectory satisfies a largest number of the set of vehicle trajectory standards.

Clause 40. The least one non-transitory storage media of clause 35, wherein the vehicle trajectory standard is one of a plurality of vehicle trajectory standards, wherein each of the plurality of vehicle trajectory standards are associated with at least one autonomous vehicle action, and wherein selecting the trajectory of the plurality of trajectories for the autonomous vehicle based on the vehicle trajectory standard associated with the autonomous vehicle action includes: determining a set of vehicle trajectory standards associated with the autonomous vehicle action; determining a prioritization of the set of vehicle trajectory standards in accordance with a priority policy, wherein a first vehicle trajectory standard is prioritized over a second vehicle trajectory standard; selecting a first trajectory from the plurality of trajectories; determining the first trajectory does not satisfy each the set of vehicle trajectory standards; and selecting a second trajectory from the plurality of trajectories, wherein the second trajectory satisfies the first vehicle trajectory standard but does not satisfy the second vehicle trajectory standard, wherein the second trajectory is the trajectory.

1. A method, comprising:
obtaining a training dataset associated with an autonomous vehicle action, the training dataset comprising trajectory data for a plurality of examples of the autonomous vehicle action and labels for each of the plurality of examples;
generating a decision tree based on the trajectory data and the labels of the training dataset;
determining a vehicle trajectory standard based on the decision tree; and
communicating the vehicle trajectory standard to at least one autonomous vehicle, wherein the at least one autonomous vehicle uses the vehicle trajectory standard to select a vehicle trajectory for the at least one autonomous vehicle.

2. The method of claim 1, wherein obtaining the training dataset associated with the autonomous vehicle action comprises:
obtaining first trajectory data associated with a first example of the autonomous vehicle action;
obtaining a first label for the first example of the autonomous vehicle action; and
associating the first label with the first trajectory data.

3. The method of claim 2, wherein obtaining the first label for the first example of the autonomous vehicle action comprises receiving an annotation from a user device, and wherein the annotation indicates a user experience of the first example of the autonomous vehicle action.

4. The method of claim 2, wherein obtaining the first label for the first example of the autonomous vehicle action comprises receiving an annotation from a simulation system, and wherein the simulation system determines the annotation based on the first trajectory data satisfying at least one safety threshold.

5. The method of claim 1, wherein generating the decision tree based on the trajectory data and the labels of the training dataset comprises:
receiving the trajectory data and the labels at a root node of the decision tree, the trajectory data comprising a set of traces that each correspond to a label and an example;
determining a first condition from a set of conditions that satisfies a branching condition;
branching the decision tree to a first node;
associating the root node with the first condition and a first sub-set of traces of the set of traces that satisfy the first condition with the first node;
determining a continuation condition is satisfied; and
in response to determining the continuation condition is satisfied, recursively, until the continuation condition is not satisfied, determining a second condition that satisfies the branching condition, branching the decision tree to second node, and associating the first node with the second condition and a second sub-set of the first sub-set of traces that satisfy the second condition with the second node.

6. The method of claim 5, wherein the branching condition is satisfied when the first condition has a highest impurity reduction measure.

7. The method of claim 5, wherein determining the first condition from the set of conditions that satisfies the branching condition comprises:
determining an impurity reduction measure for each condition of the set of conditions; and
selecting the first condition based on the first condition having a highest impurity reduction measure.

8. The method of claim 7, wherein determining the impurity reduction measure for each condition of the set of conditions comprises, for each condition:
determining a first set of traces that satisfy the condition and a second set of traces that do not satisfy the condition; and
determining the impurity reduction measure based on the first set of traces and the second set of traces.

9. The method of claim 7, wherein the impurity reduction measure is at least one of an information gain, a Gini gain, or a misclassification gain.

10. The method of claim 5, wherein the set of conditions comprise different types of conditions, and wherein each condition comprises at least one conditional operator and at least one variable.

11. The method of claim 10, wherein the least one variable is adjusted based on the set of traces.

12. The method of claim 5, wherein the continuation condition is satisfied when a sub-set of the set of traces that satisfy the second condition contains only positively labeled traces.

13. The method of claim 5, wherein determining the vehicle trajectory standard based on the decision tree comprises:
determining the vehicle trajectory standard by traversing nodes of the decision tree and joining conditions associated with traversed nodes.

14. The method of claim 1, wherein the decision tree comprises at least two levels and at least one condition at each level of the at least two levels.

15. The method of claim 14, wherein each level of the at least two levels sorts the trajectory data into different groups in accordance with the at least one condition at each level.

16. The method of claim 1, wherein the at least one autonomous vehicle uses the vehicle trajectory standard to select the vehicle trajectory for the at least one autonomous vehicle by selecting an initial trajectory from a plurality of trajectories, wherein the initial trajectory satisfies the vehicle trajectory standard.

17. The method of claim 1, wherein the at least one autonomous vehicle uses the vehicle trajectory standard to select the vehicle trajectory for the at least one autonomous vehicle by:
determining an initial trajectory;
determining the initial trajectory does not satisfy the vehicle trajectory standard; and
modifying the initial trajectory until the initial trajectory satisfies the vehicle trajectory standard.

18. A system, comprising:
at least one processor, and
at least one non-transitory storage media storing instructions that, when executed by the at least one processor, cause the at least one processor to:
obtain a training dataset associated with an autonomous vehicle action, the training dataset comprising trajectory data for a plurality of examples of the autonomous vehicle action and labels for each of the plurality of examples;
generate a decision tree based on the trajectory data and the labels of the training dataset;
determine a vehicle trajectory standard based on the decision tree; and
communicate the vehicle trajectory standard to at least one autonomous vehicle, wherein the at least one autonomous vehicle uses the vehicle trajectory standard to select a vehicle trajectory for the at least one autonomous vehicle.

19. The system of claim 18, wherein generating the decision tree based on the trajectory data and the labels of the training dataset comprises:
receiving the trajectory data and the labels at a root node of the decision tree, the trajectory data comprising a set of traces that each correspond to a label and an example;
determining a first condition from a set of conditions that satisfies a branching condition;
branching the decision tree to a first node;
associating the root node with the first condition and a first sub-set of traces of the set of traces that satisfy the first condition with the first node;
determining a continuation condition is satisfied; and
in response to determining the continuation condition is satisfied, recursively, until the continuation condition is not satisfied, determining a second condition that satisfies the branching condition, branching the decision tree to second node, and associating the first node with the second condition and a second sub-set of the first sub-set of traces that satisfy the second condition with the second node.

20. At least one non-transitory storage media storing instructions that, when executed by at least one processor, cause the at least one processor to:
obtain a training dataset associated with an autonomous vehicle action, the training dataset comprising trajectory data for a plurality of examples of the autonomous vehicle action and labels for each of the plurality of examples;
generate a decision tree based on the trajectory data and the labels of the training dataset;
determine a vehicle trajectory standard based on the decision tree; and
communicate the vehicle trajectory standard to at least one autonomous vehicle, wherein the at least one autonomous vehicle uses the vehicle trajectory standard to select a vehicle trajectory for the at least one autonomous vehicle.
